(19) United States
(12) Patent Application Publication
(10) Pub. No.: US 2016/0309214 A1
(43) Pub. Date: Oct. 20, 2016

(54) METHOD OF SYNCHRONIZING ALTERNATE AUDIO CONTENT WITH VIDEO CONTENT

(71) Applicant: Rovi Guides, Inc., Santa Clara, CA (US)

(72) Inventor: David D. Chung, Walnut Creek, CA (US)

(21) Appl. No.: 14/687,581

(22) Filed: Apr. 15, 2015

(51) Int. Cl. H04N 21/43; H04N 21/6587; H04N 21/81; H04N 21/439; H04N 21/435

(52) U.S. Cl. CPC H04N 21/4307; H04N 21/4394; H04N 21/435; H04N 21/8106; H04N 21/6587

(57) ABSTRACT

Methods and systems are disclosed herein for a media guidance application that synchronizes alternate audio on a first device with video on a second device. For example, the media guidance application may obtain an image of the video asset, determine a point in the video asset that the image corresponds to, and, from that, determine the point in the alternate audio from which playback should begin. The media guidance application may also obtain the image of the video asset in response to determining that the video and the audio assets are not synchronized. By doing so, the media guidance application may automatically, without additional manual effort on the part of the user, synchronize the alternate audio asset with the video asset.

### BACKGROUND

In conventional systems, users are able to access a plethora of video assets. Occasionally, these assets are accompanied by alternative audio that can be presented along with or in place of the original audio for the video asset. However, if the alternate audio is delivered by a different provider from the video asset or is being presented on a different device, the two can become desynchronized from one another, especially if a fast-access playback operation (e.g., fast forward) is performed.

### SUMMARY

Accordingly, methods and systems are disclosed herein for a media guidance application that synchronizes alternate audio content on a first device with video content on a second device. In particular, the media guidance application may identify a point in the alternate audio from which playback should begin on the first device based on an image of the video asset on the second device. For example, the media guidance application may obtain an image of the video asset. (e.g., through a camera integrated into the first device on which the media guidance application is implemented). The media guidance application may then determine a point in the video asset that the image corresponds to and, from that, the point in the alternate audio from which playback should begin. For example, the media guidance application may determine that the image comes from a particular scene in the video asset and thus generate the alternate audio for presentation starting from a point in the audio that corresponds to that scene. By doing so, the media guidance application may automatically, without additional manual effort on the part of the user, synchronize the alternate audio asset with the video asset.

In some aspects, a media guidance application may obtain (e.g., using control circuitry) an image of a video asset. For example, the media guidance application may receive a picture taken of a screen on which the video asset is being presented. In another example, the media guidance application may receive a frame from the video asset taken directly from a stream of the video asset.

The media guidance application may then determine (e.g., using control circuitry) a video progress point in the video asset that corresponds to the image. In some embodiments, the media guidance application may make this determination by cross-referencing the image with a database listing a plurality of images corresponding to a plurality of video progress points in the video asset. For example, the media guidance application may cross-reference the image with the database to determine that the image corresponds to a given scene in the video asset. This scene, or the time at which it occurs in the video asset, may be taken as the video progress point, In other embodiments, the media guidance application may make this determination by using image recognition techniques to identify a frame of the video asset that corresponds to the image. Again, that frame, or the time at which it occurs in the video asset, may be taken as the video progress point.

The media guidance application may then determine (e.g., using control circuitry) an audio asset that corresponds to the video asset. For example, the media guidance application may receive a user submission of an audio asset that corresponds to the video asset. In another example, the media guidance application may retrieve (e.g., from a remote source via a communications network) a list of available alternate audio assets corresponding to the video asset and prompt the user to select an audio asset from the list.

The media guidance application may then determine (e.g., using control circuitry) an audio progress point in the audio asset that corresponds to the video progress point. In some embodiments, as for the video progress point, the media guidance application may make this determination by cross-referencing the video progress point with a database listing a plurality of video progress points corresponding to a plurality of audio progress points in the audio asset. For example, the media guidance application may cross-reference the video progress point with the database to determine that it corresponds to a given time-mark in the audio asset. This time-mark may be taken as the audio progress point.

The media guidance application may then generate the audio asset for presentation at the audio progress point. For example, the media guidance application may generate the audio asset for presentation using speakers integrated into the first device on which the media guidance application is implemented. By generating the audio asset for presentation at the audio progress point, which itself corresponds to the video progress point, the media guidance application may present alternate audio that is synchronized to the video asset. Returning to a previous example, if the media guidance application has determined that the image corresponds to a frame of the video asset that occurs five minutes into the video asset and has determined that this video progress point corresponds to an audio progress point five minutes into the audio asset, the media guidance application may generate the audio asset for presentation at this five minute mark. If the media guidance application is implemented on a device other than the one on which the video asset is being presented, the audio asset may be generated for presentation on a separate device from the video asset.

In some embodiments, as discussed previously, the media guidance application may determine the audio asset that corresponds to the video asset by receiving a user submission of the audio asset (e.g., an audio asset stored on the device on which the media guidance application is implemented). In other embodiments, the media guidance application may make this determination by identifying (e.g., using control circuitry) an appropriate audio asset based on the video asset. In such an embodiment, the media guidance application may receive identifier information for the video asset. For example, the media guidance application may receive the title of the video asset and the provider from which it is being received. Based on this information, the media guidance application may identify the video asset. For example, in this case, the media guidance application may cross-reference the title of the video asset against a database of schedule information for the provider to identify the video asset. The media guidance application may then identify an appropriate audio asset based on the identified video asset. For example, the media guidance application may perform a general Internet search to find an appropriate audio asset corresponding to the identified video asset. In another example, the media guidance application may cross-reference the identified video asset with a database of available audio assets (e.g., stored locally at storage circuitry) to identify an appropriate audio asset.

In some embodiments, the media guidance application may deliver an entirety of the audio asset before generating the audio asset for presentation. For example, once the media guidance application determines the audio asset that corresponds to the video asset, the media guidance application may download the entire audio asset (e.g., from a remote source via a communications network) before initiating playback. In other embodiments, the media guidance application may deliver the audio asset. in real time while the audio asset is being generated for presentation. For example, in this case, the media guidance application may stream the audio asset (again, from a remote source via a communications network) while generating it for presentation rather than downloading the entire audio asset before playing it back.

In some embodiments, the media guidance application may determine (e.g., using control circuitry) that the video asset has undergone a fast-access playback operation. For example, the media guidance application may determine that the video asset has been rewound to a previously played point in the video asset. In some cases, the media guidance application may make this determination monitoring the video asset (e.g., using a camera) and detecting discontinuities in playback point or playback rate. In other cases, the media guidance application may make this determination by receiving a user input indicating that the video asset has undergone a fast-access playback operation (e.g., a user input requesting that the audio asset by resynchronized to the video asset).

In some embodiments, the media guidance application may obtain (e.g., using control circuitry) the image of the video asset in response to determining that the video progress point and the audio progress point are not synchronized. For example, as discussed above, the media guidance application may determine that the video asset has undergone a fast-access playback operation and, as such, the video progress point and the audio progress point are no longer synchronized. In response to this determination, the media guidance application may obtain an image of the media asset (e.g., using a camera). This image may then be used to determine the new video progress point and audio progress point as previously described.

It should be noted that the systems and/or methods described above may be applied to, or used in accordance with, other systems, methods, and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows and illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows an illustrative example of synchronizing alternate audio on a second screen with video on a main screen in accordance with some embodiments of the disclosure;

FIG. 6 is a flowchart of illustrative steps for presenting an audio asset at an appropriate audio progress point in accordance with some embodiments of the disclosure;

FIG. 7 is a flowchart of illustrative steps for presenting an audio asset at an appropriate audio progress point in accordance with some embodiments of the disclosure; and

FIG. 8 is a flowchart of illustrative steps for identifying and delivering an audio asset corresponding to a video asset in accordance with some embodiments of the disclosure.

### DETAILED DESCRIPTION OF THE DRAWINGS

Methods and systems are disclosed herein for a media guidance application that synchronizes alternate audio on a second screen with video on a main screen. In particular, the media guidance application may identify a point in the alternate audio from which playback should begin based on an image of the video asset on the main screen. For example, the media guidance application may obtain an image of the video asset (e.g., by capturing a frame from a stream of the video asset). The media guidance application may then determine a point in the video asset that the image corresponds to and, from that, the point in the alternate audio from which playback should begin. For example, the media guidance application may determine that the image comes from a particular scene in the video asset and thus generate the alternate audio for presentation starting from a point in the audio that corresponds to that scene. By doing so, the media guidance application may automatically, without additional manual effort on the part of the user, synchronize the alternate audio asset with the video asset.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

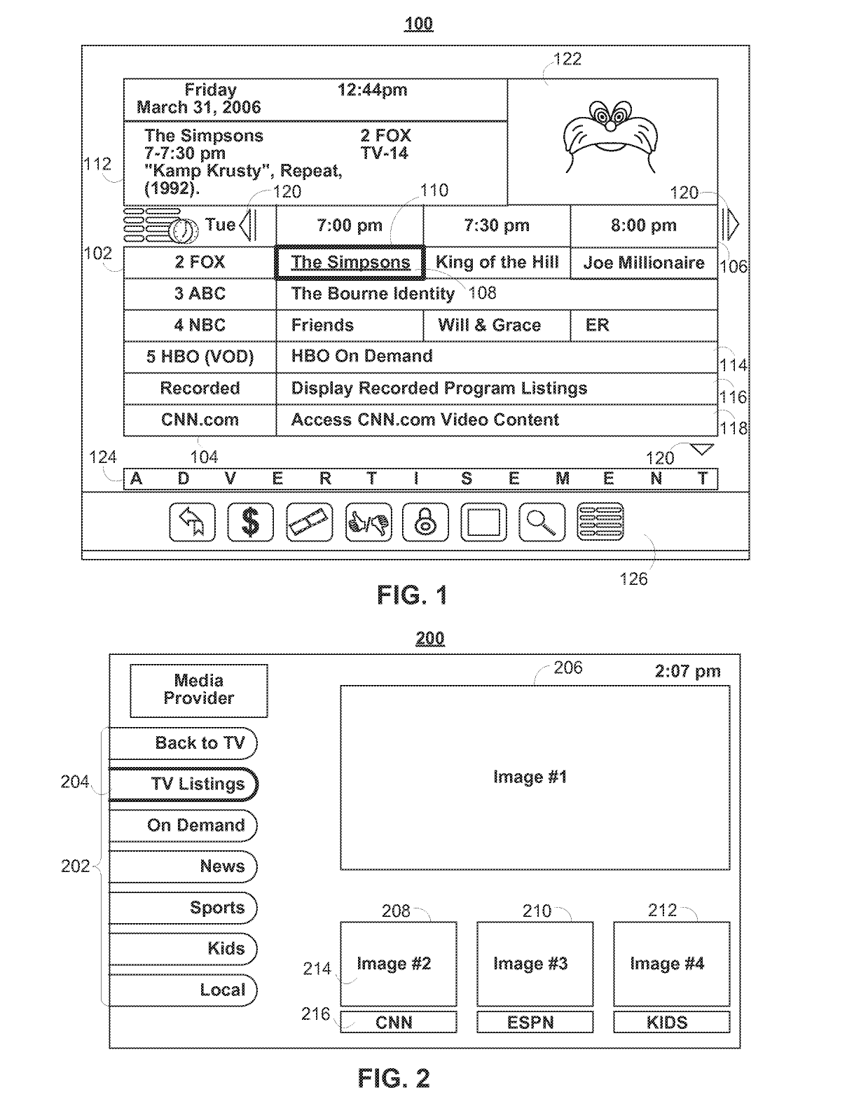

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the programs rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102, Advertisement 124 may also he for products or services related or unrelated to the content displayed in grid 102, Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

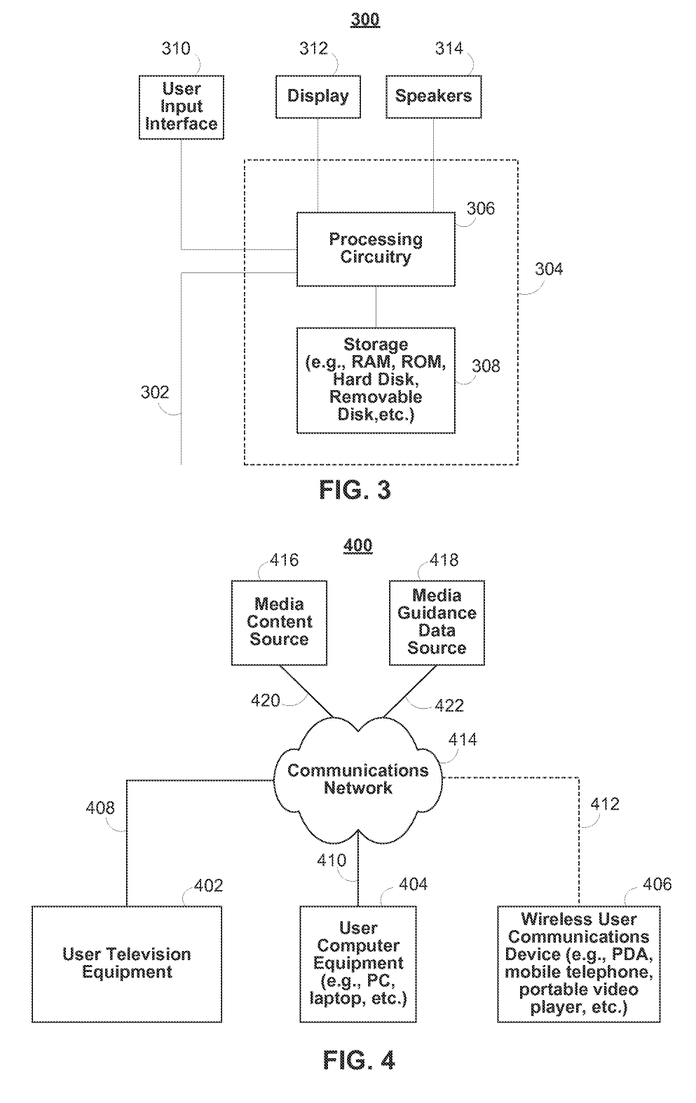

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images, In some embodiments, display 312 may be HDTV-capable, In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device,” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device, In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USE cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred to herein, a “video asset” is any media asset that includes, but is not necessarily limited to, a video signal. A video asset may also (but need not) include audio, text, still images, or other data. Examples of video assets include conventional television programs, silent movies, and music videos.

As referred to herein, an “audio asset” is any media asset that includes, but is not necessarily limited to, an audio signal. An audio asset may also (but need not) include a video signal, text, still images, or other data. Examples of audio assets include alternate audio tracks for videos, songs, and movies with sound.

As referred to herein, “alternate audio” is any audio asset that supplements, augments, or replaces the audio (or lack thereof) associated with a media asset. For example, both director's commentary, as well as alternate language dialogue tracks, may be considered to be alternate audio for a media asset. Any audio asset may be used as alternate audio, so it may also (but need not) include a video signal, text, still images, or other data.

As referred to herein, a “video progress point” is defined to be any point within a video asset. The video progress point may correspond to a particular frame, scene, or other segment of a video asset. The video progress point may also be a particular time-mark (e.g., the thirty minute mark) in the run time of a video asset.

As referred to herein, an “audio progress point” is defined to be any point within an audio asset. As for the video progress point, the audio progress point may be a segment of the audio asset, such as a given track in a track listing, or a particular time-mark in the run time of the audio asset.

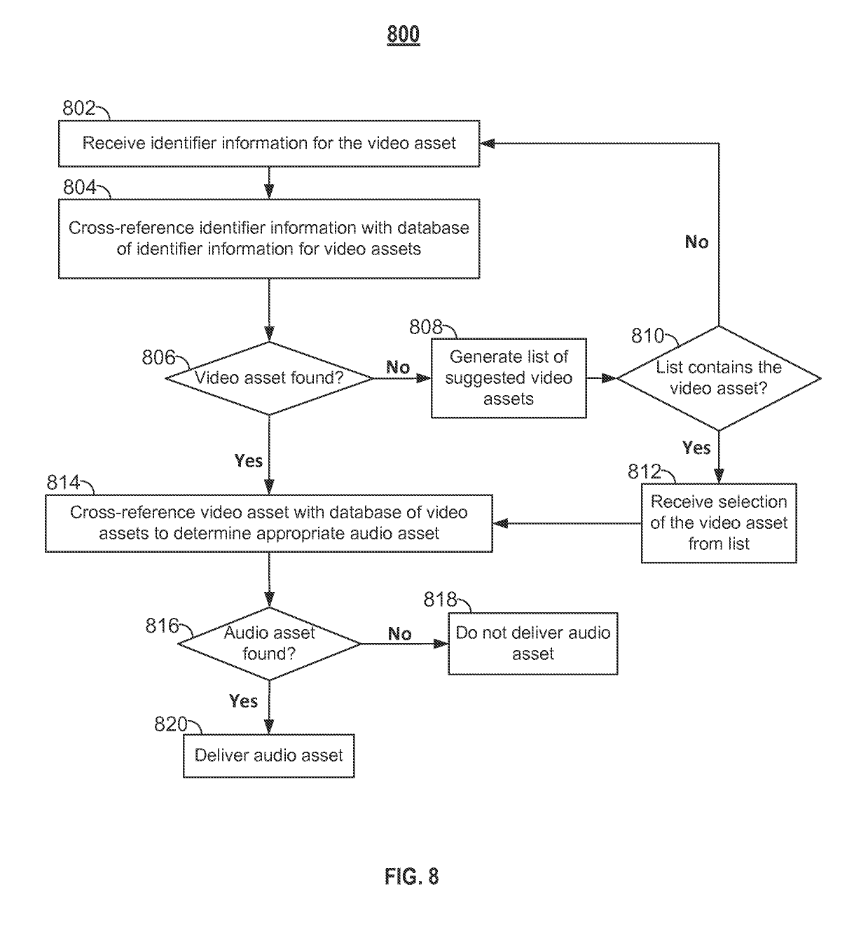

As referred to herein, “identifier information” is defined to be any piece or set of data that can be used to identify a media asset (such as, in this case, a video asset). Identifier information includes, but is not limited to, a title, author, cast member, producer, provider, broadcast time or date, genre, setting, or any other appropriate information or any combination thereof. In some cases, the media guidance application may receive an input of identifier information from a user via user input interface 310. As discussed previously (and in further detail below in regard to FIG. 8), the media guidance application may use identifier information to identify the video asset for which an audio asset has been requested.

In other cases, the media guidance application may receive identifier information along with the original audio asset (e.g., as metadata associated with the audio asset). The media guidance application may use this identifier information, for example, to identify additional alternate audio assets corresponding to the video asset. To do this, the media guidance application may cross-reference the identifier information against a database of audio assets (e.g., stored locally at storage circuitry 308 or accessed from media guidance data source 418). The media guidance application may then determine, using control circuitry 304 and based on this cross-referencing, whether any of the audio assets in the database of audio assets also correspond to the video asset. The media guidance application may then generate for display (e.g., using display 312 of second screen device 504) a list of the relevant audio assets.

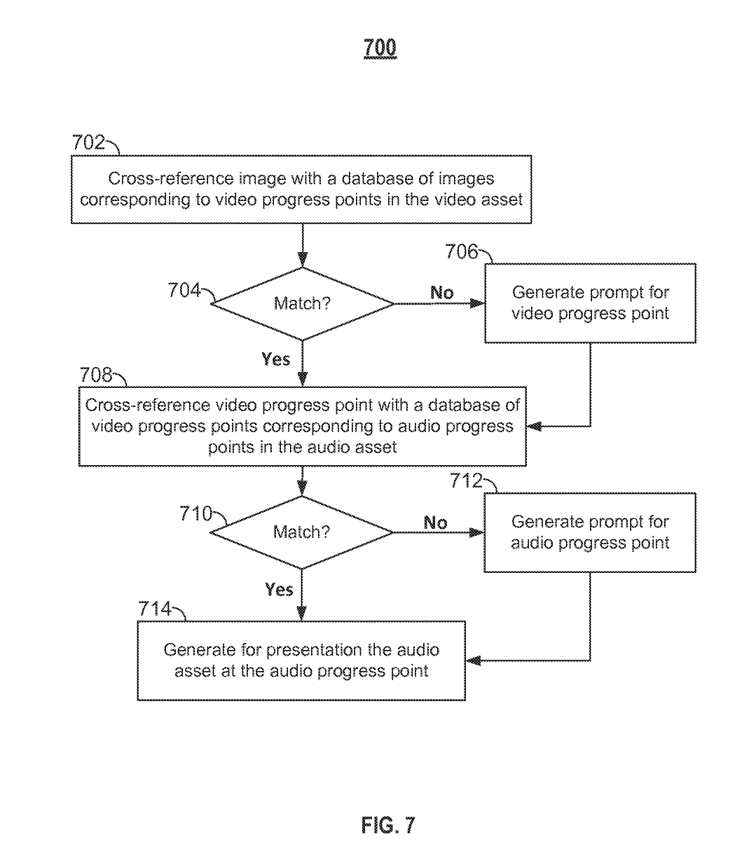

In still other cases, the media guidance application may receive identifier information when it determines the video progress point in the video asset. For example, in some cases, the media guidance application may not have identified the video asset before obtaining the image of the video asset. In such a case, the media guidance application may cross-reference the image against a database of images corresponding to video progress points in a plurality of video assets (rather than a single video asset). If the media guidance application determines that one of the images in the database match the obtained image to process discussed in further detail below with regards to FIG. 7), it may both determine the video progress point as well as receive identifier information for the video asset.

As referred to herein, a “fast-access playback operation” is defined as any operation that pertains to playing back a non-linear media asset faster than normal playback speed or in a different order than the media asset is designed to be played, such as a fast-forward, rewind, skip, chapter selection, segment selection, skip segment, jump segment, next segment, previous segment, skip advertisement or commercial, next chapter, previous chapter or any other operation that does not play back the media asset at normal playback speed. The fast-access playback operation may be any playback operation that is not “play,” where the play operation plays back the media asset at normal playback speed.

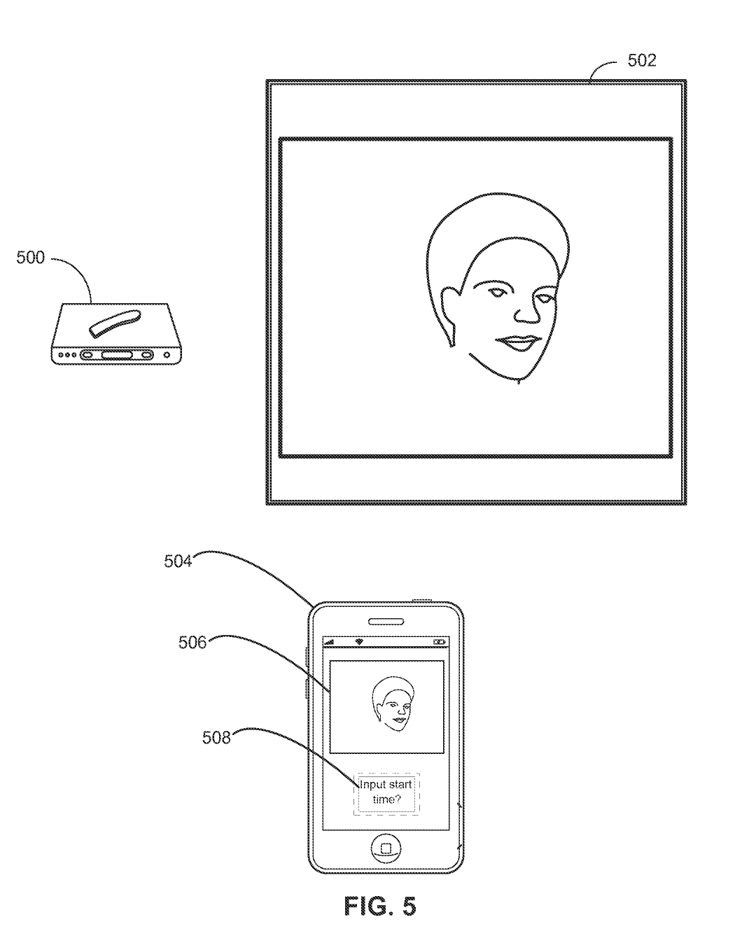

FIG. 5 shows an illustrative example of synchronizing alternate audio on a second screen with video on a main screen in accordance with some embodiments of the disclosure. The user devices are first user equipment device 500 and second user equipment device 512, which may be any of user equipment devices 402, 404, or 406.

FIG. 5 shows main screen device 500 and second screen device 504. Main screen device 500 has generated for display video asset frame 502. Second screen device 504 has generated for display obtained image 506 and optional identifier information prompt 508. Main screen device 500 and second screen device 504 may be any user equipment or device, such as user equipment device 402, 404, or 406. Video asset frame 502, obtained image 506, and optional identifier information prompt may be displayed on display 312.

In some embodiments, a media guidance application may obtain (e.g., using control circuitry 304) an image of a video asset (e.g., obtained image 506). For example, the media guidance application may receive a picture taken of a screen on which the video asset is being presented. In another example, the media guidance application may receive a frame from the video asset taken directly from a stream of the video asset.

The media guidance application may then determine (e.g., using control circuitry 304) a video progress point in the video asset that corresponds to obtained image 506. In some embodiments, the media guidance application may make this determination by cross-referencing obtained image 506 with a database listing a plurality of images corresponding to a plurality of video progress points in the video asset. For example, the media guidance application may cross-reference obtained image 506 with the database to determine that obtained image 506 corresponds to a given time-mark in the video asset (e.g., 35 minutes into the video asset), which may be taken as the video progress point. This cross-referencing is discussed in greater detail below with regards to FIG. 7.

Alternatively or additionally, the media guidance application may process an image or other data associated with a video asset to determine a video progress point. For example, the media guidance application may include and/or have access to one or more content recognition modules. A content recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify content associated with a video asset. For example, the media guidance application may receive a media asset in the form of a video (e.g., an audio/video recording of a user). The video may include a series of frames. For each frame of the video, the media guidance application may use an object recognition module to identify objects in the frame. In some embodiments, the content recognition module or algorithm may also include audio analysis and speech recognition techniques, including, but not limited to, Hidden Markov Models, dynamic time warping, and/or neural networks (as described above) to process audio data and/or translate spoken words into text in order to identify objects. The media guidance application may then determine a video progress point that corresponds to the object (or audio data). For example, the media guidance application may cross-reference the object with the database listing objects and time stamps, frames, etc. that correspond to the objet to determine a video progress point.

The media guidance application may then determine (e.g., using control circuitry 304) an audio asset that corresponds to the video asset. For example, the media guidance application may retrieve (e.g., media content source 416 via communications network 414) a list of available alternate audio assets corresponding to the video asset and determine an appropriate audio asset for the video asset based on user preferences.

The media guidance application may then determine (e.g., using control circuitry 304) an audio progress point in the audio asset that corresponds to the video progress point. In some embodiments, as for the video progress point, the media guidance application may make this determination by cross-referencing the video progress point with a database listing a plurality of video progress points corresponding to a plurality of audio progress points in the audio asset. For example, the media guidance application may cross-reference the video progress point with the database to determine that it corresponds to a given track (of a plurality of tracks) in the audio asset. The beginning of this track may be taken as the audio progress point.

The media guidance application may then generate the audio asset for presentation at the audio progress point. For example, the media guidance application may generate the audio asset for presentation using speakers 314 integrated into second screen device 504 on which the media guidance application is implemented. By generating the audio asset for presentation at the audio progress point, which itself corresponds to the video progress point, the media guidance application may present alternate audio that is synchronized to the video asset. As shown in FIG. 5, the media guidance application may be implemented on and generate the audio asset for presentation using second screen device 504 while the video asset may be generated for display by a separate device (e.g., main screen device 500).

In some embodiments, as discussed previously, the media guidance application may determine (e.g., using control circuitry 304) the audio asset that corresponds to the video asset by receiving a user submission of the audio asset (e.g., an upload of an audio asset stored at a remote source such as media content source 416 and accessed via communications network 414). In other embodiments, the media guidance application may make this determination by identifying (e.g., using control circuitry 304) an appropriate audio asset based on the video asset. This process is discussed in further detail below with regards to FIG. 8. In such an embodiment, the media guidance application may receive identifier information for the video asset. For example, the media guidance application may receive the name of the lead actor in the video asset (e.g., a movie) and the year the movie was first released. Eased on this information, the media guidance application may identify the video asset. For example, in this case, the media guidance application may cross-reference the title of the video asset against a database of movie releases to identify the video asset.

In some embodiments, the media guidance application may deliver an entirety of the audio asset before generating the audio asset for presentation using speakers 314. For example, once the media guidance application determines the audio asset that corresponds to the video asset, the media guidance application may deliver the entire audio asset (e.g., by retrieving it from storage circuitry 308 and converting it, using control circuitry 304, into a format suitable for playback using second screen device 504) before initiating playback. In other embodiments, the media guidance application may deliver the audio asset in real time while the audio asset is being generated for presentation. For example, in this case, the media guidance application may begin downloading the audio asset (e.g., from media content source 416) and begin to generate the audio asset for presentation (e.g., using speakers 314 of second screen device 504) in real time as the download is in progress.

In some embodiments, the media guidance application may determine (e.g., using control circuitry 304) that the video asset has undergone a fast-access playback operation. For example, the media guidance application may determine that the video asset has been fast-forwarded to a point in the video asset later than the portion that was most recently viewed. In some cases, the media guidance application may make this determination by monitoring the video asset (e.g., using a camera integrated into second screen device 504) and detecting discontinuities in playback point or playback rate. For example, if the media guidance application detects multiple sudden changes in the video asset (by analyzing the changes between successive images taken from the video asset), the media guidance application may determine that the video asset has undergone a fast-access playback operation.

In some embodiments, the media guidance application may obtain (e.g., using control circuitry 304) the image of the video asset (e.g., obtained image 506) in response to determining that the video progress point and the audio progress point are not synchronized. For example, as discussed above, the media guidance application may determine that the video asset has been fast-forwarded and, as such, the video progress point and the audio progress point are no longer synchronized. In response to this determination, the media guidance application may obtain an image of the media asset (e.g., by communicating with main screen device 500 and requesting the most recent frame from the video asset, such as video asset frame 502). This image may then be used to determine the new video progress point and audio progress point as previously described.

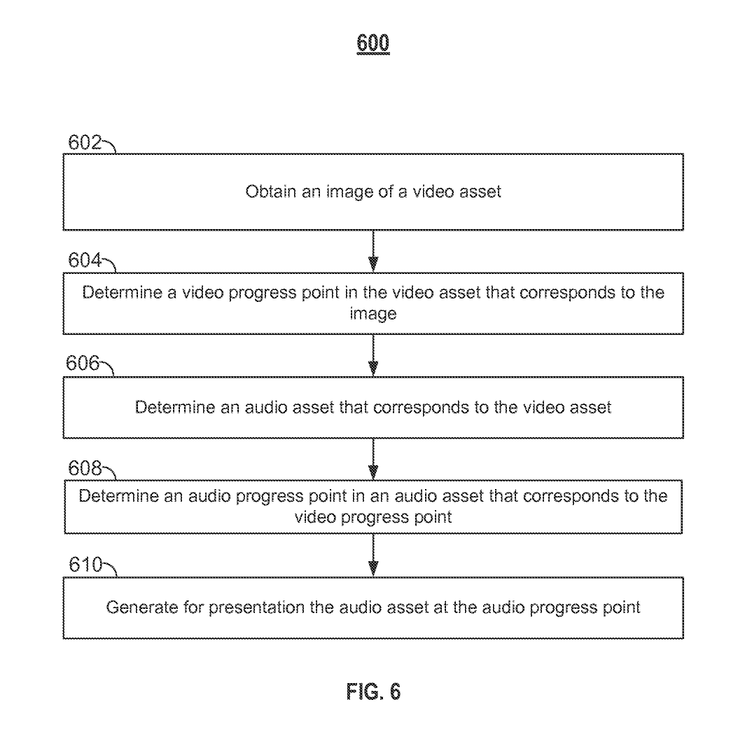

FIG. 6 is a flowchart of illustrative steps for presenting an audio asset at an appropriate audio progress point in accordance with some embodiments of the disclosure. It should be noted that process 600 or any step thereof could be performed on, or provided by, any of the devices shown in FIGS. 3-5. For example, process 600 may be executed by control circuitry 304 (FIG. 3) as instructed by control circuitry implemented on user equipment 402, 404, and/or 406 (FIG. 4) to present an audio asset. In addition, one or more steps of process 600 may be incorporated into or combined with one or more steps of any other process or embodiment.

At 602, the media guidance application obtains (e.g., using control circuitry 304) an image of a video asset. The image may be obtained locally through a camera (e.g., user input interface 310) integrated into second screen device 504. The image may also be obtained from a remote source (e.g., via communications network 414). Obtained image 506 may be a frame from the video asset, such as video asset frame 502 (for example, if the image is obtained from a stream of the video asset). Alternately, obtained image 506 may comprise a portion or the entirety of a frame from the video asset (for example, if the image is obtained from a picture taken of the video asset as generated for display by main screen device 500).

At 604, the media guidance application determines (e.g., using control circuitry 304) a video progress point in the video asset that corresponds to the image. For example, the media guidance application may determine (e.g., via control circuitry 304) a fingerprint associated with the image. A fingerprint may be any data structure generated from the image that is uniquely representative of the image and can be compared to other fingerprints. Accordingly, two identical fingerprints would correspond to the same image. The media guidance application may determine a fingerprint for the image by identifying and analyzing unique components of the image. Examples of such components or characteristics include, but are not limited to, color distributions, luminance distributions, and the distribution of edges and/or shapes in the image. The media guidance application may then access a database comprising a plurality of known images from the video asset. For example, the database (e.g., located at media guidance data source 422 and accessed via communications network 414) may comprise a list of previously-captured images from the video asset with associated video progress points. The media guidance application may then determine (e.g., via control circuitry 304) a plurality of fingerprints for the images in the database and cross-reference the fingerprint with the plurality of fingerprints. For example, the media guidance application may compare the fingerprint to the fingerprints from the images in the database to find a closest match. The media guidance application may determine that two fingerprints match based on a determination of a mathematical distance between the two fingerprints. For example, the media guidance application may compute the Hamming distance between the two fingerprints. If the media guidance application determines that the Hamming distance falls below a given numerical threshold (e.g., set by default or used on a user preference of how close the fingerprints must be to one another), the media guidance application may determine that the two fingerprints match. The media guidance application may then determine that the video progress point is the video progress point associated with the matching image in the database.

In another example, the media guidance application may compare the image to a copy of the video asset (if the video asset has been identified) to determine the video progress point. In such a case, the media guidance application may locate and access a copy of the video asset. The media guidance application may do this by performing a general Internet search, searching known databases or providers of video assets (e.g., media content source 416), or searching media assets stored at storage circuitry 308. The media guidance application may only retrieve the video asset from certain providers based on default programming, user preferences, or any other suitable criteria. For example, the media guidance application may only access the video asset if it is available free of charge. Once the media guidance application has accessed the video asset, it may compare the image to each frame of the video asset in order to find a match. The media guidance application may determine that a frame matches the image as described above. The media guidance application may then determine that the matching frame (or the time-mark within the video asset to which it corresponds) is the video progress point.

At 606, the media guidance application determines (e.g., using control circuitry 304) an audio asset that corresponds to the video asset. In some embodiments, as discussed previously, the media guidance application may determine (e.g., using control circuitry 304) the audio asset that corresponds to the video asset by receiving a user submission of the audio asset (e.g., a user selection from a list of audio assets located at storage circuitry 308). In other embodiments, the media guidance application may make this determination by identifying (e.g., using control circuitry 304) an appropriate audio asset based on the video asset. For example, as a result of the determination made in process 604, the media guidance application may also determine the identity of the video asset itself. The media guidance application may then use this information to determine an audio asset that corresponds to the video asset (e.g., by cross-referencing it, using control circuitry 304, with a database of video and/or audio assets). This process is discussed in further detail below with regards to process 814 and 816 in FIG. 8.

At 608, the media guidance application determines (e.g., using control circuitry 304) an audio progress point in an audio asset that corresponds to the video progress point. For example, the media guidance application may determine, by cross-referencing the video progress point against a database of video progress points for the media asset, that the video progress point corresponds to a particular audio progress point in the audio asset. In another example, the media guidance application may determine, based on that cross-referencing, that the video progress point corresponds to a particular time-mark in the run time of the video asset. If the audio asset has the same or similar length (e.g., within a certain threshold amount or percentage of time as set by default programming, user preferences, or any other suitable criteria), the media guidance application may determine that the audio progress point should correspond to the same time-mark in the audio asset. In still another example, the media guidance application may receive a user indication of the correct audio progress point. Processes 604 and 608 are discussed in further detail below with regard to FIG. 7.

At 610, the media guidance application generates for presentation (e.g., using control circuitry 304 and speakers 314 of second screen device 504) the audio asset at the audio progress point. The media guidance application may automatically generate the audio asset for presentation once it determines the audio progress point in process 608. Alternately, the media guidance application may generate the audio asset for presentation responsive to a user input. In another case, the media guidance application may generate the audio asset for presentation when it detects that the video asset has begun to be played back by main screen device 500. For example, if the video asset has been paused, the media guidance application may generate the audio asset for presentation when it detects that playback of the video asset has resumed. It may detect this by monitoring the video asset (e.g., by continuously obtaining images of the video asset using a camera integrated into second screen device 504) and determining that playback has resumed when there is a change in the state of the video asset (e.g., successive captured images differ from one another).

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-5 could be used to perform one or more of the steps in FIG. 6.

FIG. 7 is a flowchart of illustrative steps for presenting an audio asset at an appropriate audio progress point in accordance with some embodiments of the disclosure. It should be noted that process 700 or any step thereof could be performed on, or provided by, any of the devices shown in FIGS. 3-5. For example, process 700 may be executed by control circuitry 304 (FIG. 3) as instructed by control circuitry implemented on user equipment 402, 404, and/or 406 (FIG. 4) to present an audio asset. In addition, one or more steps of process 700 may be incorporated into or combined with one or more steps of any other process or embodiment.

At 702, the media guidance application cross-references (e.g., using control circuitry 304) the image (e.g., obtained image 506) with a database of images corresponding to video progress points in the video asset. The database may be local (e.g., stored at storage circuitry 308) or remote (e.g., media guidance data source 418 accessed via communications network 414) to the media guidance application (e.g., as implemented on main screen device 500 or second screen device 504). For example, the media guidance application may cross-reference obtained image 506 (comprising, as shown, video asset frame 502) against this database to determine a video progress point corresponding to obtained image 506.

At 704, the media guidance application determines if any of the images in the database match obtained image 506. For example, if the media guidance application has determined a fingerprint for obtained image 506 (as discussed previously), the media guidance application may compare that fingerprint to fingerprints corresponding to video progress points in a database to find a closest match. The media guidance application may determine that two fingerprints match based on a determination of a mathematical distance between the two fingerprints. For example, the media guidance application may compute the Hamming distance between the two fingerprints. If the media guidance application determines that the Hamming distance falls below a given numerical threshold (e.g., set by default or based on a user preference of how close the fingerprints must be to one another), the media guidance application may determine that the two fingerprints match. The media guidance application may then determine that the video progress point is the video progress point associated with the matching image in the database.

If the media guidance application determines at 704 that none of the images in the database match obtained image 506, the media guidance application may proceed to 706. At 706, the media guidance application may generate for display to the user a prompt for the video progress point. The media guidance application may request and receive either an absolute indication of a video progress point (e.g., a particular time-mark within the video asset) or a relative indication of a video progress point (e.g., an estimated position along a time bar). When the media guidance application receives a video progress point as a result of this prompt, the media guidance application may proceed to 708.

If the media guidance application determines at 704 that an image in the database does match obtained image 506, the media guidance application may proceed to 708. At 708, the media guidance application cross-references (e.g., using control circuitry 304) the video progress point (e.g., obtained image 506) with a database of video progress points corresponding to audio progress points in the audio asset. As at 702, the database may be local (e.g., stored at storage circuitry 308) or remote (e.g., media guidance data source 418 accessed via communications network 414) to the media guidance application (e.g., as implemented on main screen device 500 or second screen device 504). For example, the media guidance application may cross-reference the video progress point from process 704 or 706 against this database to determine an audio progress point in the audio asset.

At 710, the media guidance application determines if any of the video progress points in the database match the video progress point from process 704 or 706. The media guidance application may determine that two video progress points match if they point to the same frame, segment, or time-mark or are within a certain threshold amount or percentage of time from one another (as set by default programming, user preferences, or any other suitable criteria).

If the media guidance application determines at 710 that none of the video progress points in the database match the video progress point from process 704 or 706, the media guidance application may proceed to 712. At 712, the media guidance application may generate for display to the user a prompt for the audio progress point. The media guidance application may request and receive either an absolute indication of an audio progress point (e.g., a particular time-mark within the audio asset) or a relative indication of an audio progress point (e.g., an estimated position along a time bar). When the media guidance application receives an audio progress point as a result of this prompt, the media guidance application may proceed to 714.

If the media guidance application determines at 710 that a video progress point in the database does match the video progress point from process 704 or 706, the media guidance application may proceed to 714 as well. At 714, the media guidance application generates for presentation (e.g., using speakers 314) the audio asset at the audio progress point. As discussed previously, the media guidance application may automatically generate the audio asset for presentation once it determines the audio progress point in process 710 or receives the audio progress point in process 712. Alternately, the media guidance application may generate the audio asset for presentation responsive to a further user input (e.g., an indication to initiate playback). In another case, the media guidance application may generate the audio asset for presentation when it detects that the video asset has begun to be played back by main screen device 500. For example, if the video asset has been paused, the media guidance application may generate the audio asset for presentation when it detects that playback of the video asset has resumed. It may detect this by monitoring the video asset (e.g., by monitoring the environment using a microphone integrated into second screen device 504) and determining that playback has resumed when there is a change in the state of the video asset (e.g., the media guidance application detects sound from the video asset, if applicable).

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-5 could be used to perform one or more of the steps in FIG. 7.

FIG. 8 is a flowchart of illustrative steps for identifying and delivering an audio asset corresponding to a video asset in accordance with some embodiments of the disclosure. It should be noted that process 800 or any step thereof could be performed on, or provided by, any of the devices shown in FIGS. 3-5. For example, process 800 may be executed by control circuitry 304 (FIG. 3) as instructed by control circuitry implemented on user equipment 402, 404, and/or 406 (FIG. 4) to identify and deliver an audio asset. In addition, one or more steps of process 800 may be incorporated into or combined with one or more steps of any other process or embodiment.

At 802, the media guidance application receives (e.g., using control circuitry 304) identifier information for the video asset. As discussed previously, identifier information includes, but is not limited to, a title, author, cast member, producer, provider, broadcast time or date, genre, setting, or any other appropriate information or any combination thereof. For example, at 802, the media guidance application may receive a title (e.g., “Top Gun”) and broadcast time (e.g., 6:00 PM) for the video asset. The identifier information may be received locally (e.g., via user input interface 310) as a text input, a voice input, a gestural input, or via any other suitable input method or combination thereof. The identifier information may also be received from a remote source (e.g., via communications network 414).

At 804, the media guidance application cross-references (e.g., using control circuitry 304) the identifier information with a database of identifier information for video assets. The database may be local (e.g., stored at storage circuitry 308) or remote (e.g., media guidance data source 418 accessed via communications network 414) to the media guidance application (e.g., as implemented on second screen device 504). For example, the media guidance application may cross-reference the title and broadcast time received in process 802 against this database.

At 806, the media guidance application may determine if the video asset has been found or identified as a result of the cross-referencing of process 804. The media guidance application may determine that the video asset has been found if the identifier information associated with the video asset in the database of identifier information matches the identifier information received in process 802. For example, the media guidance application may determine that the database has identifier information for a video asset titled “Top Gun” that airs at 6:00 PM and may thus determine that the video asset has been found. Alternately, the media guidance application may determine that the video asset has been found if the identifier information associated with the video asset in the database of identifier information matches a given threshold proportion of the identifier information received in process 802. For example, the media guidance application may determine that the database has identifier information for a video asset titled “Top Gun” that airs at 7:00 PM (rather than 6:00 PM) and may thus again determine that the video asset has been found. The threshold proportion may be set by default programming, by the user, or by any other suitable method or entity.

If the media guidance application determines that the video asset has not been found (i.e., the received identifier information does not match, either in full or beyond the aforementioned threshold proportion, any of the identifier information in the database), the media guidance application may proceed to 808. At 808, the media guidance application may generate for display (e.g., using display 312) or for presentation (e.g., using speakers 314) a list of suggested video assets based on the cross-referencing of process 804. The media guidance application may compose this list, for example, by ranking the available video assets based on the degree to which their individual associated identifier information matches the received identifier information. The media guidance application may only include video assets whose associated identifier information matched some lower threshold proportion of the received identifier information. As before, this threshold proportion may be set by default programming, by the user, or by any other suitable method or entity.

At 810, the media guidance application may determine (e.g., using control circuitry 304) whether the list of suggested video assets contains the video asset associated with the received identifier information. The media guidance application may make this determination by prompting the user to select which of the video assets from the list, if any, correspond to the received identifier information. If the media guidance application determines that none of the video assets from the list correspond to the received identifier information, the media guidance application may return to 802 to receive new identifier information (e.g., by prompting the user to input new identifier information). If the media guidance application determines that one of the video assets from the list does correspond to the received identifier information, the media guidance application may proceed to 814. Similarly, if the media guidance application determines at 806 that the video asset has been found, the media guidance application may proceed to 806.

At 814, the media guidance application cross-references (e.g., using control circuitry 304) the video asset with a database of video assets to determine an appropriate audio asset. As before, the database may be local (e.g., stored at storage circuitry 308) or remote (e.g., media guidance data source 418 accessed via communications network 414) to the media guidance application (e.g., as implemented on second screen device 504). For example, the media guidance application may cross-reference the video asset determined to be found in process 806 (i.e., the video asset titled “Top Gun” and airing at 6:00 PM) with this database to determine an appropriate audio asset (e.g., an alternate audio track in a different language). The media guidance application may determine whether an available audio asset is appropriate or not according to default programming, user preferences, or any other appropriate criteria. For example, the media guidance application may determine that the user prefers audio assets that are in Spanish. As such, if both Spanish and French audio assets are available, the media guidance application would determine that the Spanish audio asset would be appropriate for that user. In another example, the media guidance application may, by default, select audio assets without explicit language over audio assets with explicit language.

At 816, the media guidance application may determine whether an audio asset has been found based on this cross-referencing. If the media guidance application determines that no audio assets are available for the video asset or none of the available audio assets are appropriate, the media guidance application may proceed to 818. At 818, the media guidance application does not deliver an alternate audio asset. If the media guidance application determines that at least one audio asset is available for the video asset and at least one of the available audio assets is appropriate, the media guidance application may proceed to 820. At 820, the media guidance application delivers the audio asset.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-5 could be used to perform one or more of the steps in FIG. 8.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, identification of a source of the portion of the media asset may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the media asset correspondences as described herein may be stored in, and retrieved from, storage 308 of FIG. 3, or media guidance data source 418 of FIG. 4. Furthermore, processing circuitry, or a computer program, may update settings associated with a user, such as user profile preferences, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for synchronizing alternate audio with a media asset, the method comprising:
obtaining an image of a video asset;
determining a video progress point in the video asset that corresponds to the image;
searching for a plurality of audio assets that correspond to the video asset;
retrieving a user profile with preferences for audio assets;
comparing data stored in the user profile to an attribute of each of the plurality of audio assets to determine which of the plurality of audio assets corresponds to the user profile;
selecting an audio asset of the plurality of audio assets which corresponds to the user profile;
determining an audio progress point in the audio asset that corresponds to the video progress point; and
generating for presentation the audio asset at the audio progress point.

2. The method of claim 1, wherein determining the video progress point comprises cross-referencing the image with a database listing a plurality of images corresponding to a plurality of video progress points in the video asset to determine the video progress point in the video asset that corresponds to the image.

3. The method of claim 1, wherein determining the audio progress point comprises cross-referencing the video progress point with a database listing a plurality of video progress points corresponding to a plurality of audio progress points in the audio asset to determine the audio progress point in the audio asset that corresponds to the video progress point.

4. The method of claim 1, wherein the audio asset is generated for presentation on a separate device from the video asset.

5. The method of claim 1, wherein determining the audio asset comprises receiving a user submission of the audio asset.

6. The method of claim 1, wherein determining the audio asset comprises:
receiving identifier information for the video asset;
identifying the video asset based on the identifier information; and
identifying an appropriate audio asset based on the video asset.

7. The method of claim 1, further comprising delivering an entirety of the audio asset before generating the audio asset for presentation.

8. The method of claim 1, further comprising delivering the audio asset in real time while the audio asset is being generated for presentation.

9. The method of claim 1, further comprising determining that the video asset has undergone a fast-access playback operation.

10. The method of claim 1, further comprising obtaining the image of the video asset in response to determining that the video progress point and the audio progress point are not synchronized.

11. A system for synchronizing alternate audio with a media asset, the system comprising:
control circuitry configured to:
obtain an image of a video asset;
determine a video progress point in the video asset that corresponds to the image;
search for a plurality of audio assets that correspond to the video asset;
retrieve a user profile with preferences for audio assets;
compare data stored in the user profile to an attribute of each of the plurality of audio assets to determine which of the plurality of audio assets corresponds to the user profile;
select an audio asset of the plurality of audio assets which corresponds to the user profile;
determine an audio progress point in the audio asset that corresponds to the video progress point; and
generate for presentation the audio asset at the audio progress point.

12. The system of claim 11, wherein the control circuitry is configured, when determining the video progress point, to cross-reference the image with a database listing a plurality of images corresponding to a plurality of video progress points in the video asset to determine the video progress point in the video asset that corresponds to the image.

13. The system of claim 11, wherein the control circuitry is configured, when determining the audio progress point, to cross-reference the video progress point with a database listing a plurality of video progress points corresponding to a plurality of audio progress points in the audio asset to determine the audio progress point in the audio asset that corresponds to the video progress point.

14. The system of claim 11, wherein the control circuitry is configured to generate the audio asset for presentation on a separate device from the video asset.

15. The system of claim 11, wherein the control circuitry is configured, when determining the audio asset, to receive a user submission of the audio asset.

16. The system of claim 11, wherein the control circuitry is further configured, when determining the audio asset, to:
receive identifier information for the video asset;
identify the video asset based on the identifier information; and
identify an appropriate audio asset based on the video asset.

17. The system of claim 11, wherein the control circuitry is further configured to deliver an entirety of the audio asset before generating the audio asset for presentation.

18. The system of claim 11, wherein the control circuitry is further configured to deliver the audio asset in real time while the audio asset is being generated for presentation.

19. The system of claim 11, wherein the control circuitry is further configured to determine that the video asset has undergone a fast-access playback operation

20. The system of claim 11, wherein the control circuitry is further configured to obtain the image of the video asset in response to determining that the video progress point and the audio progress point are not synchronized.

21-50. (canceled)
